(19) United States
(12) Patent Application Publication
(10) Pub. No.: US 2025/0019628 A1
(43) Pub. Date: Jan. 16, 2025

(54) ALCOHOLIC BEVERAGES AND METHODS FOR MAKING THE SAME

(71) Applicant: Gregory John Meffert, San Antonio, TX (US)

(72) Inventor: Gregory John Meffert, San Antonio, TX (US)

(73) Assignee: VALHALLA SPIRITS, LLC, San Antonio, TX (US)

(21) Appl. No.: 18/353,026

(22) Filed: Jul. 14, 2023

(51) Int. Cl. C12G 3/04; C12H 1/07

(52) U.S. Cl. CPC C12G 3/04; C12H 1/063

(57) ABSTRACT

The present disclosure provides improved alcoholic beverages and methods of making alcoholic beverages, such as vodka, gin, whiskey, akvavit, rum, scotch, bourbon, scotch and the like. A vodka comprises a fermentable base, water, a neutral spirit and an element from a volcanic rock. Impurities are removed from the vodka by filtering the beverage through the volcanic rock. Filtering the vodka with a volcanic rock and/or incorporating an element from the volcanic rock into the vodka increases the temporal profile of the alcohol on the tastebuds. This spreads out the overall impact of the alcohol on the tastebuds over time, thereby reducing the immediately harshness or burning sensation of the alcohol within the vodka. In addition, this process appears to inhibit activation of the bitter taste receptors, thereby reducing aftertaste and improving the overall finish of the vodka, resulting in a more pleasurable drinking experience.

### FIELD

The present disclosure generally relates to alcoholic beverages, such as vodka, gin, whiskey, akvavit, rum, scotch, bourbon, scotch and the like, and methods for producing such alcoholic beverages.

### BACKGROUND

Alcoholic spirits are the highest alcohol by volume (ABV) products made from the yeast-based fermentation of a liquid brewed to have fermentable sugars. Unlike wine or beer, however, spirits are the product of a second step of distillation that purifies and fortifies them.

One popular alcoholic spirit is vodka. Vodka is a distilled liquor that is traditionally colorless, either enjoyed neat (entirely on its own) or as the base spirit of many cocktails, including the Vodka Martini, Bloody Mary and the Cosmopolitan. While vodka's origins are uncertain, some historians believe that the distilled spirit originated for medicinal purposes in Eastern Europe—either Russian or Polish—in the fifteenth century. The name “vodka” is derived from the Slavic “voda” (water) and is interpreted as little water.

Traditional vodka is made from two raw materials: water and ethanol from the fermentation of cereal grain, such as wheat, sorghum, or rye. Many vodka brands use other base ingredients (like potatoes and sugar beets) and additives (like botanicals and spices) to achieve distinctive character in their liquor. After fermenting and distilling, vodka undergoes a filtration and refining process to remove impurities and achieve a smoother taste.

Since vodka does not have a distinct flavor, the texture and hardness of vodka can make a significant difference in the overall tasting experience. To enhance the smoothness of vodka, manufactures typically pass the water through an activated carbon filtration system to remove impurities, such as zine and copper, and to reduce the chlorine-taste of vodka. Some manufacturers chill the vodka prior to filtration to increase its density and to enhance the filtration process.

Another technique used for improving the smoothness and taste of vodka is to use the purest quality water available to reduce the amount of impurities that must be filtered out of the distilled product. A bottle of vodka typically has approximately 60 percent water and this has a significant effect on the overall character of the final distillate. In addition, the water tends to provide vodka with little to no odor or color, which improves the overall texture and mouthfeel.

While these techniques have improved the taste and mouthfeel of vodka, further refinements are needed. For example, conventional vodkas still suffer from aftertaste. Aftertaste is the taste intensity of a food or beverage that is perceived immediately after the beverage is removed from the mouth. Since this is the last sensation perceived by the drinker, aftertaste is a major component of the overall experience of the beverage.

Another drawback with conventional vodkas is that the characteristic “burning” taste of ethanol is not entirely removed with filtration, pure water sourcing, chilling or adding various flavors. The high concentrations of ethanol in vodka enhance the bitter tastebud receptors in the mouth to a degree that is not entirely eliminated with conventional processing techniques.

What is needed, therefore, are improved vodkas and improved methods of making vodkas. It would be particularly desirable to produce a vodka with a reduced bitterness or burning sensation and with less aftertaste, or a more pleasurable “finish”.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides improved alcoholic beverages and methods of making alcoholic beverages, such as vodka, gin, whiskey, akvavit, rum, scotch, bourbon, scotch and the like. The alcoholic spirits disclosed herein have a smoother taste and improved mouthfeel over conventional beverages.

In one aspect, an alcoholic beverage comprises a fermentable base, water, a neutral spirit and an element from a volcanic rock. In certain embodiments, impurities are removed from the beverage by filtering the beverage through the volcanic rock.

In other embodiments, one or more elements from the volcanic rock is incorporated into the vodka. Applicant has discovered that filtering with a volcanic rock and/or incorporating an element from the volcanic rock into the beverage increases the temporal profile of the beverage on the tastebuds. This spreads out the overall impact of the beverage on the tastebuds over time, thereby reducing the immediately harshness or “burning sensation” of the alcohol within the beverage. In addition, this process appears to inhibit activation of the other taste receptors, thereby reducing aftertaste and improving the overall finish of the beverage, resulting in a more pleasurable drinking experience.

In another aspect, an alcoholic beverage comprises a fermentable base, water and a neutral spirit, wherein the components of the beverage are chemically modified by one or more elements from a volcanic rock. In one such embodiment, the volcanic rock initiates a chemical reaction with the alcoholic beverage to change the composition of the distilled product. In another such embodiment, the chemical reaction and/or an element added from the volcanic rock changes or increases the pH of the vodka, which improves the overall taste of the beverage. In certain embodiments, the vodka has a pH of greater than 7.0, preferably greater than about 8.0. The vodka may have a pH as high as 8.3.

In certain embodiments, the element comprises a material selected from the group consisting of oxygen, silicon, basalt, basaltic alcohol derivatives. aluminum, iron, calcium, calcium carbonate, kaolinite, iron, sodium, potassium, magnesium and combinations thereof. In certain embodiments, the material is selected from the group consisting of basalt, basaltic alcohol derivatives calcium carbonate/limestone, kaolinite, iron and magnesium.

In an exemplary embodiment, the material comprises basalt, basaltic derivatives, such as such as carbonyl or ester derivatives of basalt, or minerals derived from basalt, such as calcium, anorthite, augite, pyroxene, olivine, biotite, hornblende, quartz, plagioclase feldspar (i.e., labradorite), nepheline and/or leucite. In one such embodiment, the material comprises a specific basalt comprising a primitive olivine-tholeiitic composition.

The element may comprise an oxide that includes at least one oxygen atom and one atom of silicon, aluminum, iron, calcium, sodium, potassium and/or magnesium.

In certain embodiments, the element comprises a mineral derived from the volcanic rock. The mineral preferably comprises a mineral selected from the group consisting of pyroxene, pyronine, pyridine, pryodine, Iceland spar (silfurberg), crystallized calcium carbonate, zeolite olivine, amphibole, plagioclase feldspar, hornblende, biotite mica, magnetite, quartz, basalt, basaltic alcohol derivatives and any combination thereof or some other mineral from the volcanic rock. In an exemplary embodiment, the mineral comprises basalt, basaltic derivatives, such as such as carbonyl or ester derivatives of basalt, or minerals derived from basalt, such as calcium, anorthite, augite, pyroxene, olivine, biotite, hornblende, quartz, plagioclase feldspar (i.e., labradorite), nepheline and/or leucite.

The volcanic rock may be sourced from any suitable volcanic that has erupted from a volcano. In certain embodiments, the volcanic rock is sourced from a volcano in Iceland, particularly from the Fagradalsfjall and/or the Eyjafjallajokull volcanoes. Applicant has discovered that vodka containing elements from volcanic rock from these volcanoes has a smoother taste and texture.

The fermentable base may comprise any suitable organism capable of converting a carbohydrate, such as starch or sugar, into an alcohol. Suitable fermentable bases include grain, corn, potatoes, maize, rye, rice, sorghum, yeast or a combination thereof. In certain embodiments, the fermentable base comprises wheat and/or corn.

The neutral spirit may comprise a highly concentrated ethanol that, in some cases, has been purified by means of repeated distillation. The neutral spirit may be produced from grains, corn, grapes, sugar beets, sugarcane, tubers, whey or other fermented materials.

In another aspect, a method of making an alcoholic beverage, such as vodka, comprises fermenting a fermentable base, distilling the fermentable base to form a distilled product and passing the distilled product over a volcanic rock.

In certain embodiments, the volcanic rock filters impurities from the distilled product, leaving a cleaner liquid behind. In other embodiments, an element from the volcanic rock is added or incorporated into the distilled product as the distilled product passes over the rock. In some embodiments, the volcanic rock both filters impurities and/or adds the element to the distilled product. In other embodiments, the volcanic rock initiates a chemical reaction with the alcoholic beverage to change the composition and/or pH of the distilled product.

The element comprises a material selected from the group consisting of: oxygen, silicon, aluminum, iron, calcium, sodium, potassium and magnesium. The element may comprise an oxide that includes at least one oxygen atom and one atom of silicon, aluminum, iron, calcium, sodium, potassium and/or magnesium. The element comprises a mineral, such as pyroxene, pyronine, pyridine, pryodine, Iceland spar (silfurberg), crystallized calcium carbonate, zeolite olivine, amphibole, plagioclase feldspar, hornblende, biotite mica, magnetite, quartz, any combination thereof, basalt, basaltic derivatives, such as such as carbonyl or ester derivatives of basalt, or minerals derived from basalt, such as calcium, anorthite, augite, pyroxene, olivine, biotite, hornblende, quartz, plagioclase feldspar (i.e., labradorite), nepheline and/or leucite or some other mineral from the volcanic rock.

The method may further comprise adding water to the fermentable base. The method may further comprise straining liquid from the fermentable base. In certain embodiments, the fermentable base is strained until the distilled product contains about 37.5 percent to about 50 percent alcohol.

The method may further comprise filtering the distilled product and the element. In certain embodiments, the distilled product and the element are treated with an activated carbon prior to, during, or after the filtration.

### BRIEF DESCRIPTION OF THE DRAWINGS

FIG. 1 is a graph of the transmission percentage of light at different wavelengths passing through the vodka described herein without the element from the volcanic rock; and

FIG. 2 is a graph of the transmission percentage of light at different wavelengths passing through the vodka described herein with the element from the volcanic rock.

### DETAILED DESCRIPTION OF THE PREFERRED EMBODIMENTS

Particular embodiments of the present disclosure are described hereinbelow with reference to the accompanying drawings; however, it is to be understood that the disclosed embodiments are merely exemplary of the disclosure and that the disclosure may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Well-known functions or constructions are not described in detail to avoid obscuring the present disclosure in any unnecessary detail. It should be understood also that the drawings are not drawn to scale and are not intended to represent absolute dimensions or relative size. Instead, the drawings help to illustrate the concepts described herein.

This disclosure provides improved alcoholic beverages and methods of making alcoholic beverages, such as vodka, gin, whiskey, akvavit, rum, scotch, bourbon, scotch and the like. The alcoholic beverages disclosed herein have a reduced burning sensation and an improved aftertaste than convention beverages, which results in a smoother taste and improved mouthfeel.

Taste receptors are a type of cellular receptor which facilitates the sensation of taste. When food or other substances enter the mouth, molecules interact with saliva and are bound to taste receptors in the oral cavity and other locations. Molecules which give a sensation of taste are considered “sapid”.

Bitterness is one of the most sensitive of the tastes, and many perceive it as unpleasant, sharp, or disagreeable. Research has shown that TAS2Rs (taste receptors, type 2, also known as T2Rs) such as TAS2R38 coupled to the G protein gustducin are responsible for the human ability to taste bitter substances. The TAS2R family in humans is thought to comprise about 25 different taste receptors, some of which can recognize a wide variety of bitter-tasting compounds.

Applicant has discovered that incorporating an element from a volcanic rock into an alcoholic beverage, such as vodka, reduces the bitterness or burning sensation of the vodka. It is believed that this effect is caused by an increased temporal profile of the vodka on the tastebuds, particularly the bitter taste receptors, such as TAS2R. This spreads out the overall impact of the vodka on these tastebuds over time, thereby reducing the immediately harshness or burning sensation of the vodka.

Aftertaste is the taste intensity of a vodka that is perceived immediately after that vodka is removed from the mouth. The aftertastes of different vodkas can vary by intensity and over time, but the unifying feature of aftertaste is that it is perceived after the vodka is either swallowed or spat out. Characteristics of a vodka's aftertaste are quality, intensity, and duration. Quality describes the actual taste of the vodka and intensity conveys the magnitude of that taste. Duration describes how long a vodka's aftertaste sensation lasts.

The neurobiological mechanisms of taste (and aftertaste) signal transduction from the taste receptors in the mouth to the brain have not yet been fully understood. However, the primary taste processing area located in the insula has been observed to be involved in aftertaste perception. Because a lingering taste sensation is intrinsic to aftertaste, the molecular mechanisms that underlie aftertaste are presumed to be linked to either the continued or delayed activation of receptors and signaling pathways in the mouth that are involved in taste processing. Chemicals in food interact with receptors on the taste receptor cells located on the tongue and the roof of the mouth.

In the context of aftertaste, the combination of both receptor-dependent and receptor-independent processes have been proposed to explain the signal transduction mechanisms for foods with distinct aftertastes, particularly those that are bitter, such as vodka. The receptor-dependent process is the same as what was described above. However, the receptor-independent process involves the diffusion of bitter, amphiphilic chemicals, such as quinine, across the taste receptor cell membranes. Once inside the taste receptor cell, these compounds have been observed to activate intracellular G-proteins and other proteins that are involved in signaling pathways routed to the brain. The bitter compounds thus activate both the taste receptors on the cell surface, as well as the signaling pathway proteins in the intracellular space.

Intracellular signaling may be slower than taste cell receptor activation since more time is necessary for the bitter compounds to diffuse across the cell membrane and interact with intracellular proteins. This delayed activation of intracellular signaling proteins in response to the bitter compounds, in addition to the extracellular receptor signaling is proposed to be related to the lingering aftertaste associated with bitter foods and beverages. The combination of both mechanisms leads to an overall longer response of the taste receptor cells to the bitter foods and beverages, and aftertaste perception subsequently occurs.

Applicant believes that filtering distilled alcohol with a volcanic rock inhibits activation of the bitter taste receptors. This reduces the aftertaste and improves the overall finish of the alcohol, resulting in a more pleasurable drinking experience.

In another aspect, an alcoholic beverage comprises a fermentable base, water and a neutral spirit, wherein the components of the beverage are chemically modified by one or more elements from a volcanic rock. In one such embodiment, the volcanic rock initiates a chemical reaction with the alcoholic beverage to change the composition of the distilled product.

Vodka is typically meant to be a neutral spirit, which means that the pH of vodka is typically in the range of 6.0 to 7.0. Less-expensive American vodkas, for example, typically have a lower pH of around 4.0 because manufacturers add citric acid as a balancing agent for the taste. The citric acid lowers the pH of these vodkas.

Applicant has discovered that the pH of the vodkas described herein is increased by the volcanic rock, either through a chemical reaction with the rock or by adding an element from the volcanic rock to the vodka. In certain embodiments, the vodka has a pH of greater than 7.0, preferably greater than about 8.0. The vodka may have a pH as high as 8.3. This improves the overall taste of the vodka.

In one embodiment, an alcoholic beverage includes a fermentable base, water, a neutral spirit and an element from a volcanic rock. In certain embodiments, the element comprises a material selected from the group consisting of oxygen, silicon, basalt, basaltic alcohol derivatives aluminum, iron, calcium, calcium carbonate, kaolinite, iron, sodium, potassium, magnesium and combinations thereof. In certain embodiments, the material is selected from the group consisting of basalt, basaltic alcohol derivatives calcium carbonate/limestone, kaolinite, iron and magnesium. In an exemplary embodiment, the material comprises basalt, basaltic derivatives, such as carbonyl or ester derivatives of basalt, or minerals derived from basalt, such as calcium, anorthite, augite, pyroxene, olivine, biotite, hornblende, quartz, plagioclase feldspar (i.e., labradorite), nepheline and/or leucite.

The element may comprise an oxide that includes at least one oxygen atom and one atom of silicon, aluminum, iron, calcium, sodium, potassium and/or magnesium.

In certain embodiments, the element comprises a mineral derived from the volcanic rock. The mineral preferably comprises a mineral selected from the group consisting of pyroxene, pyronine, pyridine, pryodine, Iceland spar (silfurberg), crystallized calcium carbonate, zeolite olivine, amphibole, plagioclase feldspar, hornblende, biotite mica, magnetite, quart, basalt or basaltic alcohol derivatives, any combination thereof or some other mineral from the volcanic rock.

In an exemplary embodiment, the mineral comprises basalt, basaltic derivatives, such as such as carbonyl or ester derivatives of basalt, or minerals derived from basalt, such as calcium, anorthite, augite, pyroxene, olivine, biotite, hornblende, quartz, plagioclase feldspar (i.e., labradorite), nepheline and/or leucite.

The volcanic rock may be sourced from any suitable volcanic that has erupted from a volcano. In certain embodiments, the volcanic rock comprises Tholeiitic basalt, transitional alkalic basalt and/or alkalic basalt.

In certain embodiments, the volcanic rock is source from a volcano in Iceland, particularly from the Fagradalsfjall and/or the Eyjafjallajokull volcanoes. Applicant has discovered that vodka containing elements from volcanic rock from these volcanoes has a smoother taste and texture.

The Fagradalsfjall volcano is a tuva volcano formed in the last glacial period on the Reykanes Peninsula around 40 kilometers from Reykjavik, Iceland. Fagradalsfjall is also the name for the wider volcanic system covering an area 5 kilometers wide and 16 kilometers long between the Svartsengi and Krysuvik systems. The element in Applicant's vodka may be found in this wider volcanic system.

The Eyjafjallajokull volcano is one of the smaller ice caps of Iceland, north of Skogar and west of Myrdalsjokull. The ice cap covers the caldera of a volcano with a summit elevation of about 1,651 meters. The element in Applicant's vodka may be found within this ice cap.

The main component of ordinary lava is silicon dioxide (SiO2). According to the Institute of Earth Sciences (Háskóli Íslands), analysis of the lava produced during the eruption of the Fagradalsfjall volcano revealed a basalt with a “primitive olivine-tholeiitic” composition. These and other chemical criteria such as the content of trace elements testify to the formation of a magma in the upper mantle at a depth of 17 km or deeper. The magma rose directly from the upper mantle and not, as usual, from a magma chamber in the Earth's crust a few kilometers below the surface. However, it did pause near the surface in a volcanic dyke. A few larger porphyritic crystals in the otherwise fine-grained rock are evidence of this. These crystals are composed of the minerals plagioclase feldspar as well as olivine, clinopyroxene, and spinel.

Basalt is a volcanic rock with a relatively low content of silicon dioxide (45-52% SiO2 by weight)—in contrast to andesite (57-63% SiO2 by weight) or rhyolite (more than 70 weight % SiO2). With increasing silicon dioxide content and decreasing temperature, lava becomes increasingly viscous. Thinly liquid basaltic lava forms pahoehoe lava with a smooth, often knobbly or rope-like surface. At the Fagradalsfjall volcano with its very liquid basaltic lava, significant forms of pahoehoe and accompanying typical “lava sculptures” can be seen.

However, it should be understood that the volcanic rock may be sourced from other locations in Iceland or outside of Iceland. Suitable volcanoes for sourcing the volcanic rock in Iceland include Rykjanes, Krysuvik, Brennisteinsfjoil, Hengill, Hromundartindur, Grimsnes, Geysir, Western and Eastern Langiokull, Hofsjokull, Tungnafellsjokull, Vestmannaeyjar, Katia, Tindfjallajokull, Hekla-Vatnafjoil, Torfajokull, Baroarbunga-Veiovotn, Grimsvotn, Kverkfjoil, Askja, Frerinamur, Krafia, Peistareykir, Oraefajokull, Esjufoil, Snaefell, Liosufjoil, Lysuskaro and Snaefellsjokull.

The fermentable base may comprise any suitable organism capable of converting a carbohydrate, such as starch or sugar, into an alcohol. Suitable fermentable bases include grain, corn, potatoes, maize, rye, rice, sorghum, yeast or a combination thereof. In certain embodiments, the fermentable base comprises wheat and/or corn.

In one preferred embodiment, the fermentable base is wheat. The wheat may comprise Winter Wheat, Spring Wheat or Summer Wheat.

In another embodiment, the fermentable base comprises corn, or a combination of wheat and corn. The corn may comprise Blue Indian Corn, which may comprise several related varieties of flint corn. The Blue Indian Corn provides a sweeter flavor, softer mouthfeel and gentler finish to the vodka.

The neutral spirit may comprise a highly concentrated ethanol that, in some cases, has been purified by means of repeated distillation. The neutral spirit may be produced from grains, corn, grapes, sugar beets, sugarcane, tubers, whey or other fermented materials.

The water used in the vodkas disclosed herein may be sourced from a variety of locations well known in the art. In one embodiment, the water is sourced directly from glacial water, such as glacial water in Norway, Iceland, Alaska and the like. The glacial water has a relatively low mineral content and may be similar in taste and other qualities to rainwater.

This disclosure also includes methods of making an alcoholic beverage, such as vodka. The methods include fermenting a fermentable base, distilling the fermentable base to form a distilled product and passing the distilled product over a volcanic rock. In certain embodiments, the method includes adding an element from the volcanic rock into the distilled product.

To make the fermentable base, various grains, such as wheat and corn, are mixed together, heated and stirred until the mixture is substantially uniform and ready to ferment. The fermentable base is then stored for a period of time, preferably about one to two weeks, to fully ferment the mixture. The fermenting process can be conducted with any suitable process known to the art. After undergoing the fermentation process, the fermentable base produces ethanol, which is then sieved out of the solid mixture, leaving pure, liquid alcohol.

After fermentation, the vodka is distilled. Distillation is a process that purifies a liquid by heating and vaporizing it, then collecting the vapor as it recondenses into a liquid. The resulting liquid is more alcoholic and purer because it leaves behind many impurities when it evaporates. The vodka may be distilled once, twice or multiple times.

In certain embodiments, flavors are added to the vodka during the distillation process. The flavors may, for example, include botanicals, herbs, lemon, lime, grapefruit, mandarin orange, cranberry, blueberry, cucumber, mint, organic chiles, habaneros, lemongrass, peppers, serranos vanilla, rose, ginger, peach or any other flavor that may be desired.

After the distillation process, water is added to the product to achieve the desired alcohol by volume. In certain embodiments, the water is source from glacial water as described above. In certain embodiments, the alcohol by volume is between about 37.5 percent to about 50 percent. The water may be added during the fermentation process, distillation or both.

The alcohol from the distillation process is then passed over a volcanic rock, such as one of the volcanic rocks described above. In certain embodiments, the volcanic rock filters impurities from the distilled product, leaving a cleaner liquid behind. In other embodiments, an element from the volcanic rock is added or incorporated into the distilled product as the distilled product passes over the rock.

In other embodiments, the volcanic rock initiates a chemical reaction with the alcoholic beverage to change the composition and/or pH of the distilled product. In one such embodiment, the alcohol is continuously passed through the volcanic rock until the pH of the alcohol is increased. In some embodiments, the pH is increased to at least about 7.0, or at least about 8.0, preferably about 8.3.

The volcanic rock may be treated at certain points throughout the process to regain its initial adsorbent capacity. Alternatively, the volcanic rock may be replaced with fresh volcanic rock periodically throughout the process. In one embodiment, the volcanic rock is placed into cartridges that can be replaced when necessary.

In certain embodiments, the vodka may also be filtered to remove impurities with a suitable water filtration system, such as reverse osmosis, activated carbon and the like. In one embodiment, the vodka is passed through a membrane with pores sized to only allow water molecules and small contaminants therethrough to filter out the majority of the unwanted particles. In another embodiment, the vodka is filtered with other substances through adsorption before and/or after passing through the volcanic rock. The substances may include, for example, activated carbon, such as charcoal. In one such embodiment, the vodka is first passed through the volcanic rock and then filtered twice through activated carbon. This produces a final product with a clean mouthfeel.

The filtered product, the distilled product and/or the fermentable base may pass through a heat exchanger to decrease the temperature of the vodka. In certain embodiments, the alcohol is cooled to a temperature of about 5 degrees Celsius to about −20 degrees Celsius for a period of hours or days. Other ingredients, such as sugar, may be added to the vodka and the final product may be consecutively filtered through a series of microfilters.

### EXAMPLES

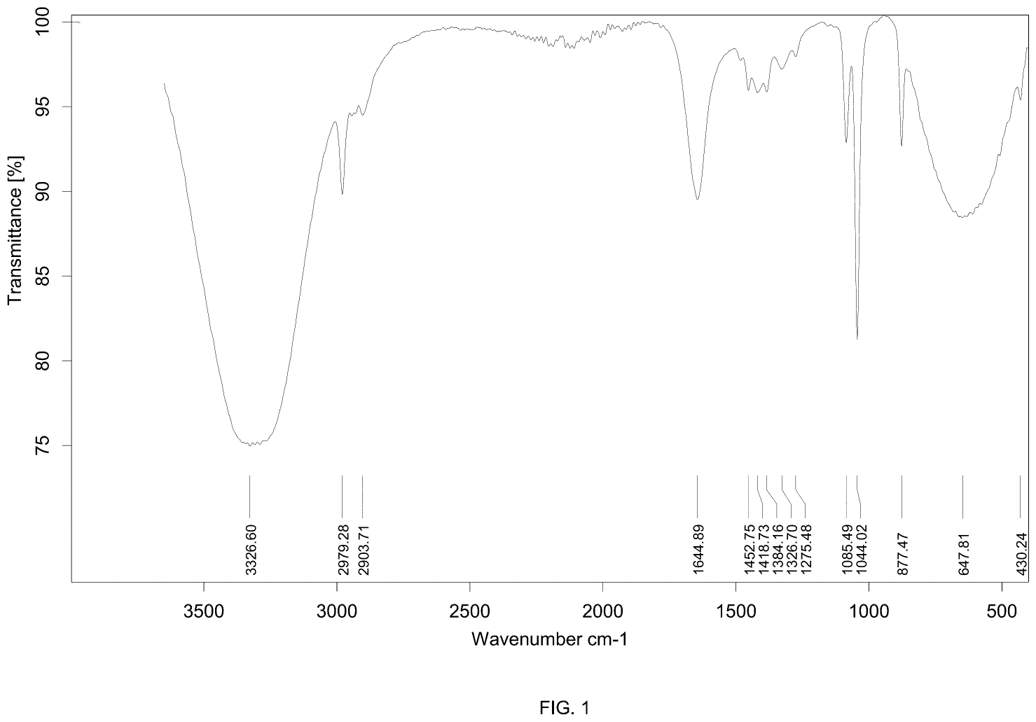

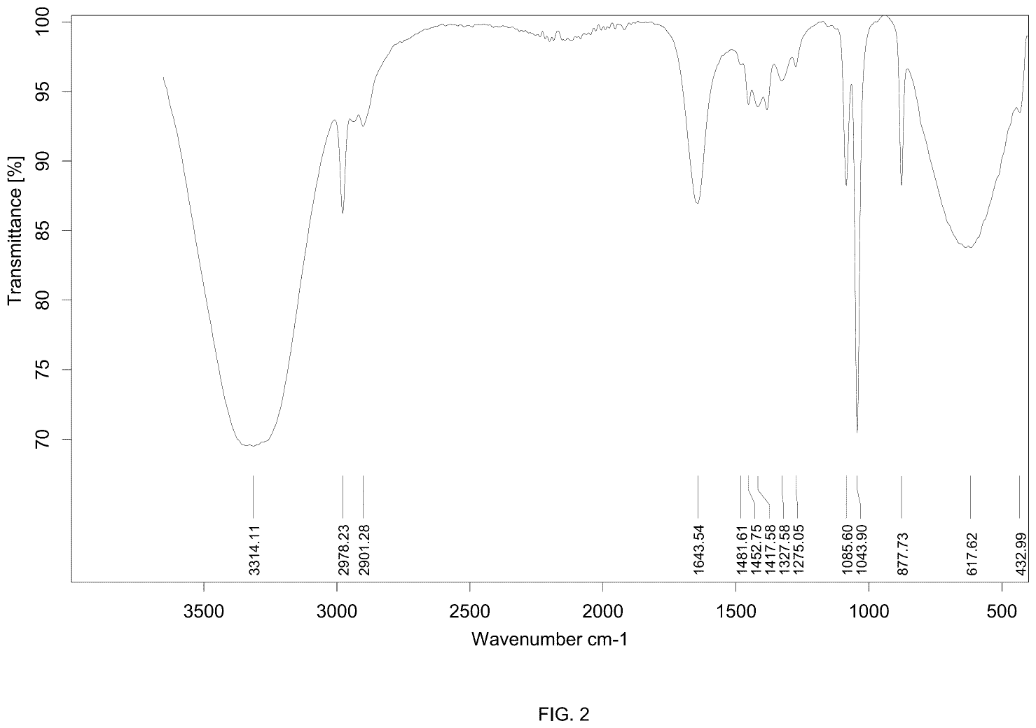

Applicant conducted testing of the vodka described herein with and without passing the vodka over the volcanic rock to determine the additional element that is incorporated into the vodka from the volcanic rock. FIGS. 1 and 2 illustrate the results of this testing.

FIG. 1 is a graph of the transmission percentage of light at different wavelengths passing through the vodka described herein without passing the vodka over the volcanic rock FTIR is below. FIG. 2 is a graph of the transmission percentage of light at different wavelengths passing through the vodka described herein after passing the vodka over the volcanic rock. The transmission percentage was determined through Fourier Transform Infrared Spectroscopy, also known as FTIR Analysis or FTIR Spectroscopy. FTRI Spectroscopy is an analytical technique used to identify organic, polymeric, and, in some cases, inorganic materials. The FTIR analysis method uses infrared light to scan test samples and observe chemical properties.

The FTRI Spectroscopy illustrates that the vodka has a different chemical composition after passing over the volcanic rock. Specifically, around the wavelength of 1044.02 cm−1, the light transmittance drops from about 82% light transmittance to about 69% light transmittance after the vodka has been passed over the volcanic rock. In addition, at a wavelength of about 3326.60 cm−1 to about 3324.11 cm−1, the light transmittance drops from about 75% to about 70% after the vodka has been passed over the volcanic rock.

The decrease in light transmittance at these wavelengths indicates the presence of a dissolved material in the vodka (i.e., an element dissolved from the volcanic rock). It is known by those of skill in the art that most elements in volcanic rock will not dissolve at standard temperatures. However, certain elements, such as basalt, basalt derivatives, calcium carbonate or limestone, kaolinite, iron and magnesium will at least partially dissolve at room temperatures. In addition, these elements would also raise the PH of the vodka.

The FTRI and PH testing demonstrate that one or more elements have been incorporated into the vodka from the volcanic rock. In particular, the evidence demonstrates that at least some portion of one or more of the elements: basalt, basalt derivatives, calcium carbonate or limestone, kaolinite, iron and magnesium have been incorporated into the vodka.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the disclosure. Accordingly, the present disclosure is intended to embrace all such alternatives, modifications, and variances. As well, one skilled in the art will appreciate further features and advantages of the present disclosure based on the above-described embodiments. Accordingly, the present disclosure is not to be limited by what has been particularly shown and described, except as indicated by the appended claims.

What is claimed is:

1. An alcoholic beverage comprising:
a fermentable base;
water;
a neutral spirit; and
an element from a volcanic rock.

2. The alcoholic beverage of claim 1, wherein the fermentable base comprises wheat, grain, corn, potatoes, maize, rye, rice, sorghum, yeast or a combination thereof.

3. The alcoholic beverage of claim 1, wherein the neutral spirit comprises ethanol.

4. The alcoholic beverage of claim 1, wherein the element comprises a material selected from the group consisting of: oxygen, silicon, basalt, basaltic derivatives aluminum, iron, calcium, calcium carbonate, kaolinite, iron, sodium, potassium, magnesium and combinations thereof.

5. The alcoholic beverage of claim 1, wherein the element comprises basalt, basaltic derivatives or minerals derived from basalt.

6. The alcoholic beverage of claim 1, wherein the beverage is vodka.

7. The alcoholic beverage of claim 1, wherein the beverage has a pH of at least about 7.0.

8. A method of making an alcoholic beverage comprising:
fermenting a fermentable base;
distilling the fermentable base to form a distilled product; and
contacting the distilled product with a volcanic rock.

9. The method of claim 8, further comprising adding an element from the volcanic rock into the distilled product.

10. The method of claim 8, further comprising filtering the distilled product with the volcanic rock.

11. The method of claim 8, further comprising initiating a chemical reaction between the volcanic rock and the distilled product.

12. The method of claim 8, further comprising increasing a pH of the distilled product with the volcanic rock.

13. The method of claim 8, further comprising straining liquid from the fermentable base.

14. The method of claim 8, further comprising filtering the distilled product and the element.

15. The method of claim 8, further comprising adding water to the distilled product.

16. The method of claim 8, wherein the fermentable base comprises wheat, grain, corn, potatoes, maize, rye, rice, sorghum, yeast or a combination thereof.

17. The method of claim 8, wherein the element comprises a material selected from the group consisting of oxygen, silicon, aluminum, iron, calcium, sodium, potassium, magnesium, basalt, basaltic alcohol derivatives and combinations thereof.

18. The method of claim 8, wherein the element comprises basalt, basaltic derivatives or minerals derived from basalt.

19. The method of claim 8, wherein the alcoholic beverage is vodka.

20. A vodka produced from the method of claim 8.
